(19) United States
(12) Patent Application Publication
(10) Pub. No.: US 2014/0297350 A1
(43) Pub. Date: Oct. 2, 2014

(54) ASSOCIATING EVENT TEMPLATES WITH EVENT OBJECTS

(71) Applicant: HEWLETT-PACKARD DEVELOPMENT COMPANY, L.P., Houston, TX (US)

(72) Inventors: Adi Kidron, Tel-Aviv (IL); David Levin, Jerusalem (IL); Erez Yaary, Tel-Aviv (IL); Yael Keren, Tel-Aviv (IL)

(73) Assignee: HEWLETT-PACKARD EVELOPMENT COMPANY, L.P., Houston, TX (US)

(21) Appl. No.: 13/851,134

(22) Filed: Mar. 27, 2013

(51) Int. Cl. G06Q 10/06

(52) U.S. Cl. CPC G06Q 10/06311
USPC 705/7.18; 705/7.13

(57) ABSTRACT

Example embodiments relate to associating event templates with event objects. In some examples, a scheduling server may create an event object that provides information about an event. The scheduling server may receive input from a client device to select an event template that includes defined content, for example, non-logistical content. The scheduling server may associate the selected event template with the event object, thereby causing at least part of the defined content of the selected event template to be displayable when users access the event object.

### BACKGROUND

Various calendar software programs may provide users with an electronic or digital version of a calendar. These software programs may also provide an address book and/or a contact list of persons who can be added as attendees of an appointment, and may provide a list of appointments, attendees for each appointment and details for each appointment. Regarding implementation, these software programs may be a local package designed for individual use or may be a server-based package that allows users to access the electronic calendar via a network (e.g., and via an exchange server). These software programs may also allow users (e.g., organizers) to share information about an appointment with other users (e.g., attendees) of the calendar program, and may allow users to view details about an appointment that is upcoming, for example, the date, time and room number. In some scenarios, users may access a server-based calendar via a client device (e.g., a desktop computer or mobile device such as a smartphone, tablet, PDA or the like).

### BRIEF DESCRIPTION OF THE DRAWINGS

The following detailed description references the drawings, wherein:

FIG. 1 is a block diagram of an example scheduling server computing device for associating event templates with event objects;

FIG. 2 is a block diagram of an example scheduling server computing device for associating event templates with event objects, where the scheduling server is in communication with an example client computing device;

FIG. 3A is a diagram of an example display screen that may be displayed via a user interface displayed on device display;

FIG. 3B is a diagram of an example display screen that may be displayed via a user interface displayed on device display;

FIG. 3C is a diagram of an example display screen that may be displayed via a user interface displayed on device display;

FIG. 3D is a diagram of an example display screen that may be displayed via a user interface displayed on device display;

FIG. 4A is a diagram of an example display screen that may be displayed via a user interface displayed on device display;

FIG. 4B is a diagram of an example display screen that may be displayed via a user interface displayed on device display;

FIG. 5 is a flowchart of an example method for associating event templates with event objects; and

FIG. 6 is a flowchart of an example method for associating event templates with event objects.

### DETAILED DESCRIPTION

In some scenarios, users of a calendar program (e.g., meeting organizers) may get in the habit of scheduling meetings without thinking in advance regarding the precise goals of the meetings and/or how to effectively and efficiently structure or conduct the meeting. In other scenarios, a user of a calendar program (e.g., a meeting organizer) may know the goals and structure of the meeting; however, the user may not have an efficient way to share this information with attendees of the meeting before the meeting and/or during the meeting. In these scenarios, attendees of the meeting may show up to the meeting without being well prepared. In other scenarios, a user of a calendar program (e.g., a meeting organizer) may know the loose goals and structure of the meeting; however, the user may benefit from being able to view and use a previously-used meeting structure and/or meeting content.

As described above, various calendar programs may allow users (e.g., organizers) to share information about an appointment with other users (e.g., attendees) of the calendar program. However, in various calendar programs, this information is limited to logistical information about the meeting, e.g., the meeting date, meeting time, room number, call-in information and the like. Various calendar programs allow users to select from meeting templates when scheduling a meeting, where information from the meeting template is inserted into the meeting details in an attendee's calendar. In various calendar programs, these meeting templates include information that is limited to logistical information such as audio conferencing information and meeting duration times. Various other calendar programs may use local templates to present meeting details to users in various time zones, where the local templates format meeting details to the particular time zones. Again, these templates affect logistical information such as meeting times.

The present disclosure describes associating event templates with event objects, where the event template may include pre-made content (e.g., topics or information to be presented during the event, a listing and/or organization of time segments during the event, media to be played or shown during the event, etc.). An event template may be associated with a meeting object, for example, during the creating of a new event object. Associating a template with an event object may cause the pre-made content to be integrated with the meeting object (e.g., such that the pre-made content is visible when attendees view the meeting object). The present disclosure may describe receiving reviews (e.g., ratings and/or comments) of templates (e.g., in a crowd sourcing manner) and displaying reviews when a user (e.g., a meeting organizer) is browsing templates. Templates may be presented or suggested to a user based on template reviews, the previous reviews of particular attendees of a meeting and/or various other factors.

The present disclosure may provide benefits over various calendar software programs with templates that offer only logistical information (e.g., meeting date, meeting time, room number). The present disclosure may improve the efficiency and effectiveness of event organizers, for example, because they may not have to develop event content from scratch for each meeting, and may be able to structure their events based on a structure and/or content that has worked well in the past. The present disclosure may improve the efficiency and effectiveness of event attendees, for example, because they may learn the structure (e.g., general topics) of the meeting in advance. This may allow them to set the right expectations for the purpose of the meeting and prepare for the meeting. In this respect, ineffective and unnecessary meetings may be avoided, which may save resources of a company. Additionally, event organizers can explore different ways of conducting an event that have been successful in the past. Additionally, organizations (e.g., companies) can use templates to specify the manner in which certain types of meetings should be conducted and/or to include particular content that should be presented during the meetings.

Throughout this disclosure, it should be understood how the terms “user”, “attendee” and “organizer” are related. The term “user” may refer to a person who uses a client device, for example, client computing device 260 of FIG. 2. The term “attendee” may refer to a specific type of user, wherein the user/attendee is invited to attend an event, and wherein an event object (explained in more detail below) may indicate the attendees of an event. The term “organizer” may refer to a specific type of user, wherein the user/organizer creates the event object and/or presents, runs or organizes the event, and wherein the event object may indicate the organizer of the event. Throughout this disclosure, it should be understood that the term “client device” may be used as a shorthand term or a more generalized term for “client computing device.” Likewise, the term “scheduling server” may be used as a shorthand term or a more generalized term for “scheduling server computing device.” For the purposes of this disclosure, the term “event” may refer to an appointment or meeting, a web-based appointment or meeting, or any other event where an organizer of the event may run the event and/or present content to at least one event attendee.

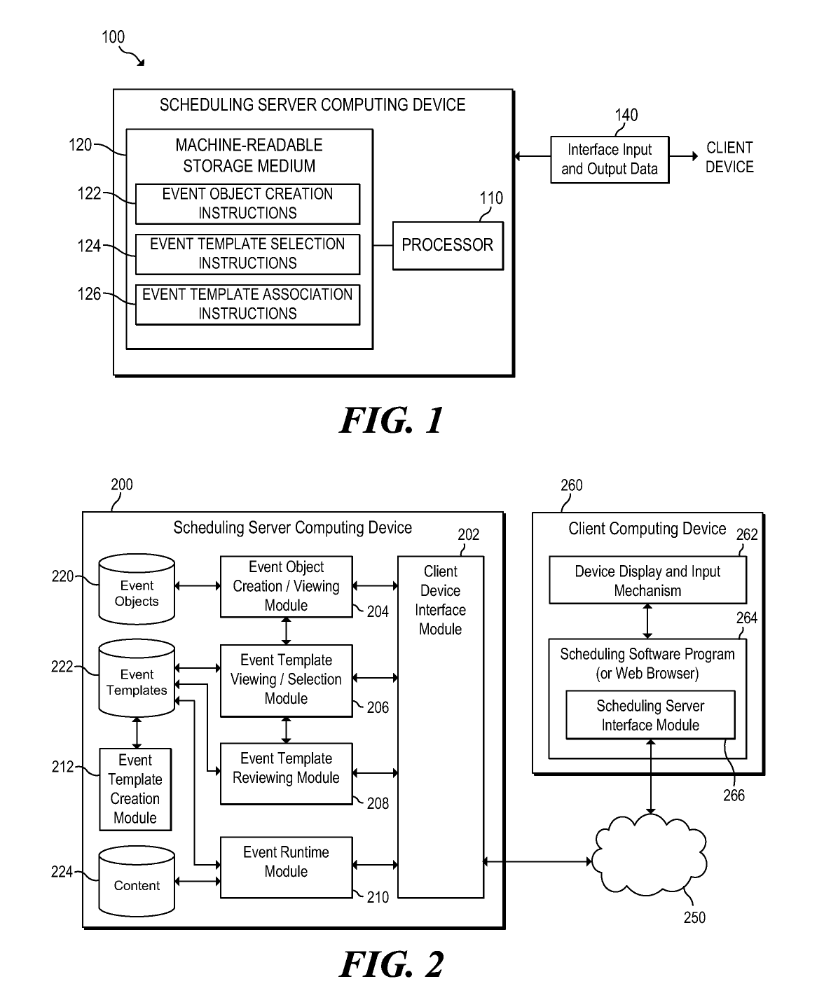

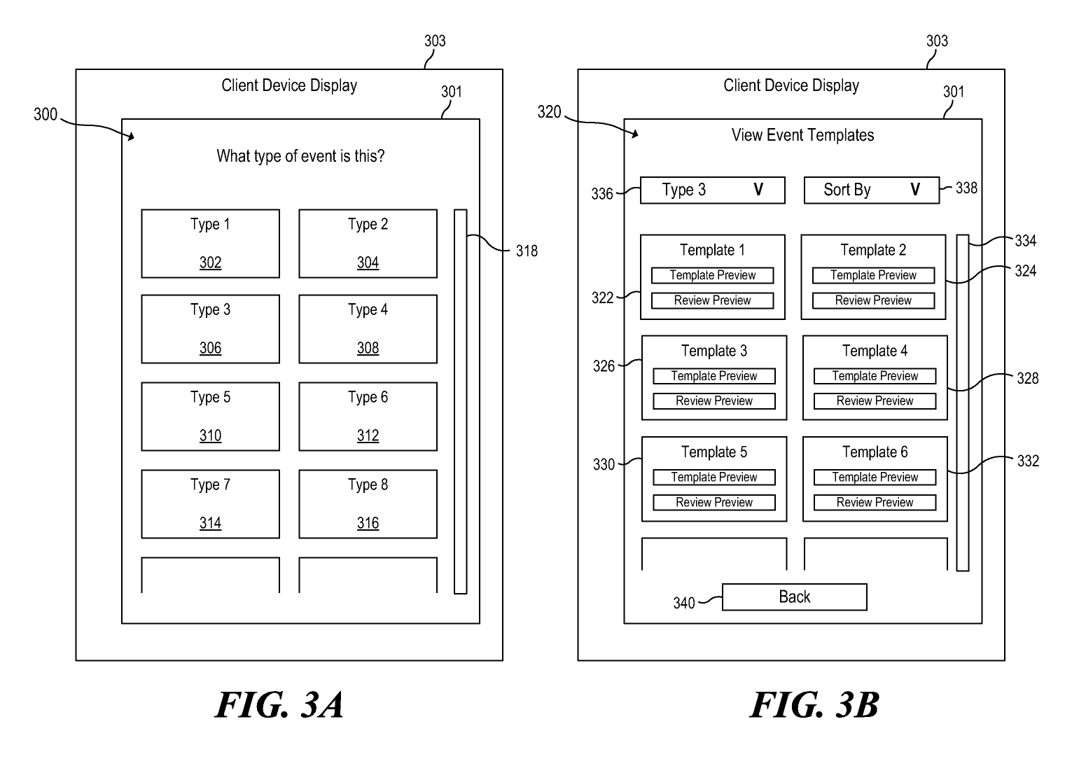

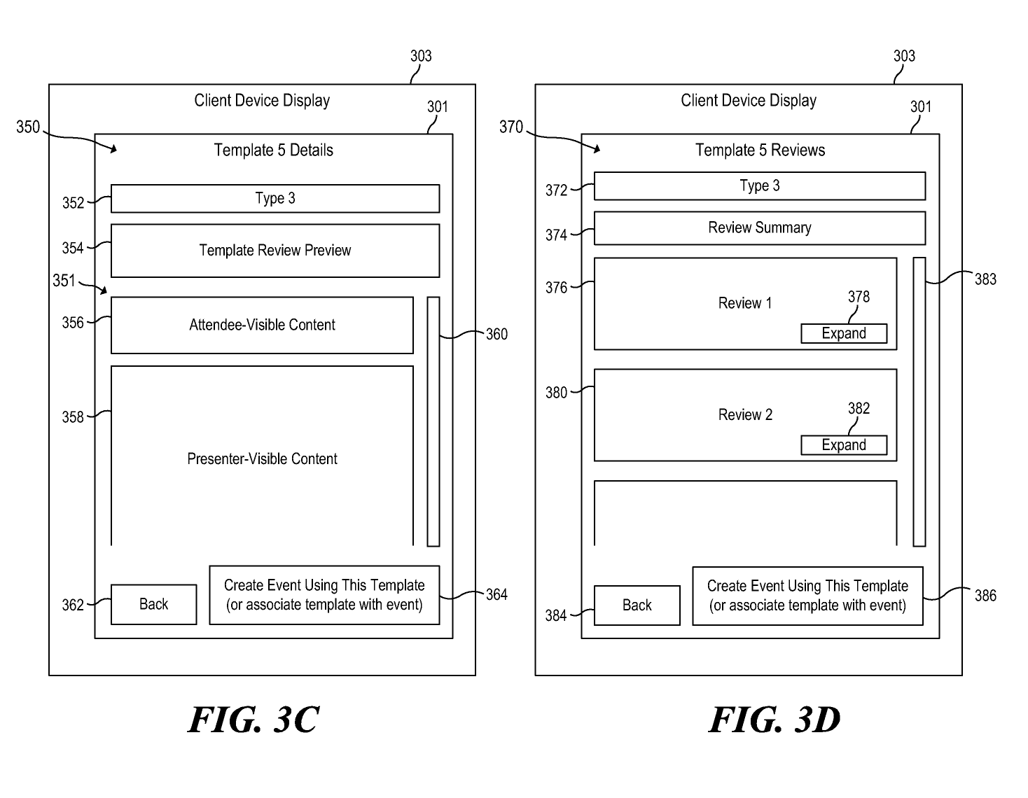

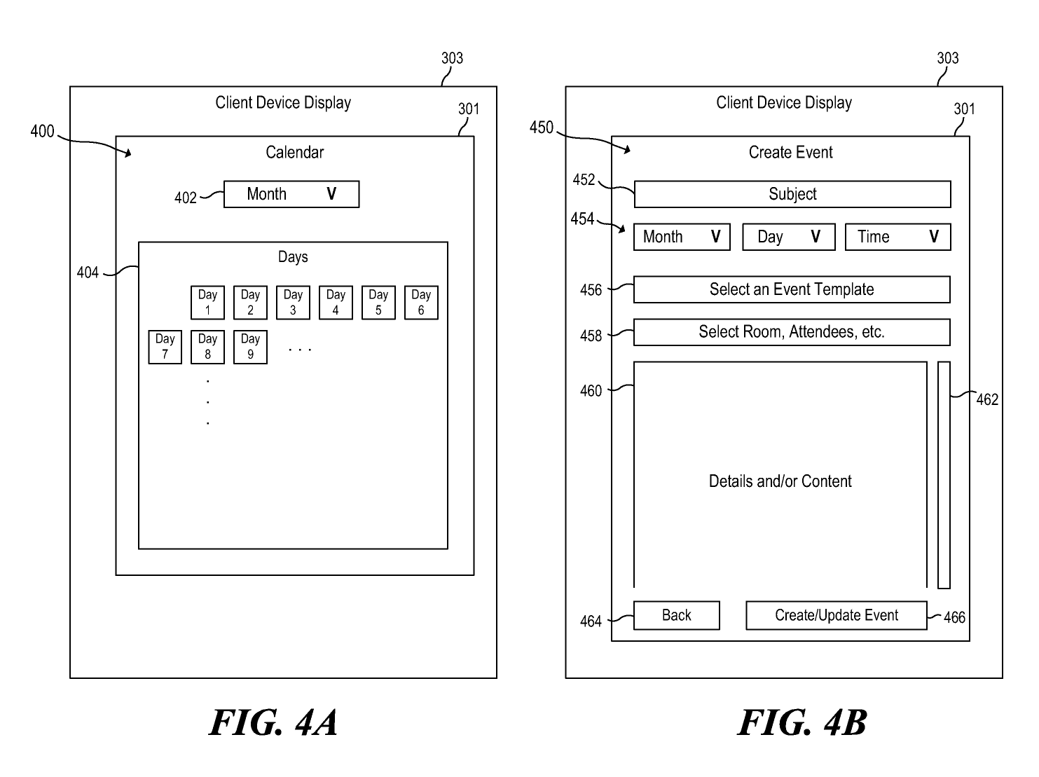

FIG. 1 is a block diagram of an example scheduling server computing device 100 for associating event templates with event objects. Scheduling server computing device 100 may be any computing device accessible to at least one client device, such as client computing device 260 of FIG. 2. Scheduling server computing device 100 may be in communication with at least one client device via a network, for example, the internet, an intranet or other type of network. Scheduling server computing device 100 may receive interface input data 140 from client devices, for example, to allow users of the client devices to access a user interface (e.g., user interface 301 of FIGS. 3A to 4B) in the scheduling server computing device. Scheduling server computing device 100 may transmit interface input data (also generally indicated by reference number 140) to client devices, for example, to present to users of the client devices various screens of a user interface (e.g., user interface 301 of FIGS. 3A to 4B). More details regarding an example scheduling server computing device may be described below with respect to scheduling server computing device 200 of FIG. 2. In the embodiment of FIG. 1, scheduling server computing device 100 includes a processor 110 and a machine-readable storage medium 120.

Processor 110 may be one or more central processing units (CPUs), microprocessors, and/or other hardware devices suitable for retrieval and execution of instructions stored in machine-readable storage medium 120. Processor 110 may fetch, decode, and execute instructions 122, 124, 126 to, among other things, associating event templates with event objects. As an alternative or in addition to retrieving and executing instructions, processor 110 may include one or more electronic circuits comprising a number of electronic components for performing the functionality of one or more of instructions 122, 124, 126. With respect to the executable instruction representations (e.g., boxes) shown in FIG. 1, it should be understood that part or all of the executable instructions and/or electronic circuits included within one box may, in alternate embodiments, be included in a different box shown in the figures or in a different box not shown.

Machine-readable storage medium 120 may be any electronic, magnetic, optical, or other physical storage device that stores executable instructions. Thus, machine-readable storage medium 120 may be, for example, Random Access Memory (RAM), an Electrically-Erasable Programmable Read-Only Memory (EEPROM), a storage drive, an optical disc, and the like. Machine-readable storage medium 120 may be disposed within scheduling server computing device 100, as shown in FIG. 1. In this situation, the executable instructions may be “installed” on the device 100. Alternatively, machine-readable storage medium 120 may be a portable (e.g., external) storage medium, for example, that allows scheduling server computing device 100 to remotely execute the instructions or download the instructions from the storage medium. In this situation, the executable instructions may be part of an installation package. As described in detail below, machine-readable storage medium 120 may be encoded with executable instructions for generating event notifications based on learned traveling times between locations. As described in detail below, machine-readable storage medium 120 may be encoded with executable instructions for associating event templates with event objects.

Event object creation instructions 122 may allow users to create at least one event object. Event object creation instructions 122 may allow a user to associate an event template with a newly created event object or an existing event object, as explained in more detail below. More details regarding an example event object creation/viewing module may be described below with respect to module 204 of FIG. 2. Event template selection instructions 124 may allow users to browse event templates, select particular event templates and view details of particular event templates (e.g., reviews associate with templates). More details regarding an example event template viewing/selection module may be described below with respect to module 206 of FIG. 2. Event template association instructions 126 may associate an event template with an event object, for example, a newly created event object or an existing event object. More details regarding associating event templates with event objects may be described below with respect to at least one of modules 204 and 206 of FIG. 2.

FIG. 2 is a block diagram of an example scheduling server computing device 200 for associating event templates with event objects. Scheduling server computing device 200 may be similar to scheduling server computing device 100 of FIG. 1, for example. Scheduling server computing device 200 may be any computing device accessible to a client device over the Internet or some other network. As illustrated in FIG. 2 and described herein, scheduling server computing device 200 may communicate with at least one client computing device (e.g., client computing device 260) to allow users of client devices to, among other things, view event templates, associate event templates with event objects and review event templates, as explained in more detail below.

As illustrated in FIG. 2, scheduling server computing device 200 may include a number of modules 202, 204, 206, 208, 210, 212. Each of these modules may include a series of instructions encoded on a machine-readable storage medium and executable by a processor of the scheduling server computing device 200. In addition or as an alternative, each module may include one or more hardware devices including electronic circuitry for implementing the functionality described below. With respect to the modules described and shown herein, it should be understood that part or all of the executable instructions and/or electronic circuitry included within one module may, in alternate embodiments, be included in a different module shown in the figures or in a different module not shown. Scheduling server computing device 200 may include a number of repositories 220, 222, 224. The term repository may generally refer to a data store that may store digital information. Each of these repositories may include or be in communication with at least one physical storage mechanism (e.g., hard drive, solid state drive, tap drive or the like) capable of storing information including, for example, a digital database, a file capable of storing text, media, code, settings or the like, or other type of data store.

Client device interface module 202 may communicate with at least one client device (e.g., client device 260). Client device interface module 202 may allow the at least one client devices to interface with other modules of the scheduling server computing device 200, for example, modules 204, 206, 208, 210. In one example scenario, a client device (e.g., client device 260) may communicate with client device interface module 202 via a scheduling server interface module 266. In the example of FIG. 2, client device interface module 202 may be included in or be part of scheduling software program 264. Alternatively, client device interface module 202 may be included in or be part of a web browser (also generally indicated by reference number 264). A user of the client device 260 may view information received via the scheduling server interface module 266 using a device display 262. A user of the client device 260 may input information transmitted to via the scheduling server interface module 266 using an input mechanism (also generally indicated by reference number 262).

Client device interface module 202 may provide a user interface (e.g., user interface 301 of FIGS. 3A to 4B) that may be displayed to a user of a client device (e.g., client device 260). The user interface may display a number of screen or pages that facilitate the communication of information to users and the receiving of information from users. Example user interface screens may be shown with regard to FIGS. 3A to 4B, and may be explained in more detail below.

Event object creation/viewing module 204 may be accessible to a user via client device interface module 202. Event object creation/viewing module 204 may allow a user to create at least one event object. The term “event object” may refer to a digital record or file that includes information about an event. An event object may include a subject or title, a date of the event, an event location, invited attendees to the event, an organizer of the event (may be considered an attendee as well), and potentially other details about the event. Event object creation/viewing module 204 may store created event objects in event object repository 220. Event object creation/viewing module 204 may access event objects that are stored in repository 220, for example, to receive information about event objects and/or to transmit information about event objects to client devices (e.g., client device 260). Event object creation/viewing module 204 may allow a user to associate (e.g., by communicating with module 206) an event template with a newly created event object or an existing event object, as explained in more detail below. In this respect, scheduling server 200 may allow for the selection and association of pre-defined content (e.g., associated with an event template) with an event object during the creation of an event object.

Event templates repository 222 may store at least one event template. The term “event template” may refer to a digital object or file that is capable of being associated with an event object such that when a client device (e.g., client device 260) views the event object, the event object is formatted and/or displayed in a way that is specified by the event template. An event template may include content (or a link to content) that may be displayed when an event object is accessed by a user of a client device. As one specific example, if a user accesses an event object, the user may see a window (e.g., similar to section 460 of FIG. 4), the purpose of the window being to display details about the event. The details shown in this window may be inserted by an organizer of the event, such that attendees of the event can see details about the event prior to the event start time. If the event object is associated with an event template, when the user accesses the event, this window may include content that is automatically inserted into the window based on the content of the event template.

Event template content may be non-logistical, substantive event information, as opposed to logistical information (e.g., meeting date, meeting time, room number, call-in information and the like). Non-logistical, substantive event information may include details about the structure of the event or particular content that will be provided during the event. Examples of event template content, without limitation, are topics or information to be presented during the event, listing and/or organization of time segments during the event, media to be played or shown during the event, a link (e.g., URL, URI, etc.) to external information and/or external media, and computer code that when executed embeds external information and/or external media in an event object. In some examples, event template content may be interactive, for example, such that a user may enter input. Interactive content may be implemented by computer code (e.g., HTML code) that executes when the event object and/or template is access. As one specific example, if a manager is conducting a 1-on-1 meeting with a worker, the manager may access the event template during the meeting (e.g., via event runtime module 210). The interactive content may display as at least one form (e.g., an HTML form) that allows the manager to enter and/or submit text, for example, in response to questions that the manager asks the worker. Once a template is associated with an event object, the template content may be integrated with the event object (e.g., template content may be displayed in a section like section 460 of FIG. 4). Further examples of event template content will be described in more detail with regard to various example scenarios and categories of event templates.

Event templates may be categorized by type of event, for example, a brainstorm meeting, a company status meeting, a question and answer (Q&A) meeting, a 1-on-1 meeting, a performance review, a scrum status meeting, a feature demo, a free lecture, etc. The type of content (and content structure) associated with an event template may depend on the type or category of event. In this respect, event templates may be indexed and searched (e.g., by a user) by type or category of event, and a user may expect certain types of content when selecting certain types of event templates. The following will describe a few example scenarios that may describe various categories or types of event templates and when and/or how these templates may be used.

In one example scenario, an event object may be created for a 1-on-1 meeting, for example, between a worker and a manager. If an event template was not used, the event object may provide information that is limited to logistical information, such as the time of the meeting, the attendees and the like. The event organizer (e.g., the manager) could enter additional details into the event object (e.g., explaining the agenda of the meeting, etc.), but the organizer would have to generate this content or find this content elsewhere to enter into the event object. Instead, an event template may be used that includes pre-made content, and when the event organizer associated the event template with the event object, the pre-made content may be automatically inserted into the event object. In the scenario of the 1-on-1 meeting, an event template may include content such as a list of topics for the manager to discuss with the worker, and example ice-breaker ideas to get a conversation started for each topic.

In another example scenario, an event object may be created for a company status meeting, and an event template for this type of event may include topics to discuss during the meeting, such as items that have performed well over the last quarter and items that could be improved for the next quarter. In another example scenario, an event object may be created for a brainstorming meeting, and an event template for this type of event may include a listing and/or organization of time segments during the event. For example, each attendee to the meeting may be allotted several minutes to provide input, followed by a discussion period. In another example scenario, an event object may be created for a Q&A meeting, and an event template for this type of event may include a period of time for pre-planned questions, followed by an open question and answer period. One example benefit of event templates with pre-made content may be that various types of events (e.g., for company events) may follow strict rules about what must be covered during the event. For example, for focal performance reviews or yearly performance reviews, a company may require that certain topics be covered, and may require that these topics be covered in a certain manner. By using an event template for these specific types of events, an event organizer can be confident that the event will be conducted as it should. Additionally, by using event templates, attendees of events may view key points or topics of the event in advance, which may help an attendee prepare for an important event such as a performance review where the attendee's preparedness to discuss particular topics may be important.

As indicated above, an event template may include content (or a link to content) that may be displayed when and event object is accessed by a user. Event templates may include attendee-visible content and/or organizer-visible content. Attendee-visible content may refer to content that is visible to attendees of an event when the attendees access an event object associated with the event template. Attendee-visible content may also be visible to organizers of an event. Organizer-visible content may refer to content that is visible to (e.g., only to) an organizer of an event when the organizer accesses an event object associated with the event template. In this respect, an event template may provide, for example, some content that informs attendees of the general structure of the meeting while providing an organizer of a meeting with more detailed content. Organizer-visible content may be used by the organizer (or some other presenter) during the meeting as well. Examples of organizer-visible content, without limitation, are opening statements and/or stories, detailed outlines of discussion points, presentation slides, presentation instructions (e.g., what to do and how long it should take) and presentation tips.

Various pieces of content associated with an event template may be designated as attendee-visible content or organizer-visible content at various times. For example, when an event organizer associates an event template with an event object, the event template may initially indicate which content of the total available content should be attendee-visible and which content should be organizer visible. The scheduling server computing device may allow an organizer to change (e.g., after the creation of the event object) whether certain content is designated as attendee-visible or organizer visible. In some scenarios, an organizer (or other presenter) may share some organizer-visible content (e.g., during a meeting), while keeping other content private to only the organizer/presenter.

Event templates may be created in various ways. For example, an event creator may use a software program to create a template and then upload the template to the event template repository 222, for example, using event template creation module 212. As another example, an event creator may access event template creation module 212 via a remote client device, and event template creation module 212 may include routines or services for creating event templates. Scheduling server 200 may maintain (e.g., stored in event template creation module) profiles for creators of event templates, and these profiles may be visible to users that are viewing event templates (e.g., using module 206). In this respect, a user that is viewing an event template may see which creator/profile is associated with an event template. Users may also search for, sort or filter event templates based on the creator of the templates. As one example, users may wish to view only event templates created by a popular or highly-rated template creator (e.g., gurus in a particular business segment or well-known authors of presentation materials). As another example, users may wish to view only event templates created by their company (e.g., a company may create templates to set expectations on how certain meetings should take place).

Event template viewing/selection module 206 may be accessible to a user via client device interface module 202. Event template viewing/selection module 206 may be in communication with event object creation/viewing module 204. In this respect, a user may access the event template viewing/selection module 206 while creating or viewing an event object (e.g., via module 204). As one specific example, a user may access (e.g., via module 202) calendar software. The user may then select an option in the calendar software to create an event (e.g., employing module 204), and a window for creating an event may display to the user. Then, the user may select an option on the window to associate a template with the event (e.g., employing module 206). Alternatively, a user may view and select an event template using event template viewing/selection module 206, and then may associate the event template with a particular event object (e.g., via module 204), for example, by dragging a window or icon related to a particular template onto an area associated with an event object. In this respect, a user may create a new meeting object based on a template.

Event template viewing/selection module 206 may allow a user to browse event templates in event templates repository 222. Event template viewing/selection module 206 may present the contents of repository 222 as a catalog of event templates, for example, categorized by type of template. Event template viewing/selection module 206 may allow a user to select a particular event template and view the details of the event template, for example, the content associated with the event template, and at least one review associate with the template. Event templates may be dynamic, meaning that event templates, as they are visible to users, may update in real time when details about the event template are changed or updated. Details about the event template may be changed or updated in various ways, for example, if a creator of an event template modifies the event template or if users of an event template submit reviews (e.g., ratings and/or comments) of the event template. Further details regarding how templates may be browsed, viewed, selected, and associated with an event object may be described below with regard to FIGS. 3A to 4B.

Event template reviewing module 208 may be accessible to a user via client device interface module 202. Event template reviewing module 208 may allow users to review an event template, for example, by submitting review information to be associated with a particular template. Review information may be, for example and without limitation, rating(s) related to the event and/or the event template, answer(s) to at least one question related to the event and/or the event template, and/or comment(s) related to the event and/or the event template. Reviews (review information) of a template may be stored and associated with the template (e.g., in repository 222), and then reviews associated with the template may be visible to users that are viewing the template (e.g., using module 206). In this respect, users that are browsing templates may see ratings and/or comments from other users (e.g., in a crowd sourcing manner), and ratings, for example, may be used to search for, sort or filter templates. Reviews of a template may be sent (e.g., via a messaging system in scheduling server 200) to organizers of an event that use the template and/or to the creator of the template. In this respect, reviews from users that experienced the template or associated event in the past may be used to improve the template or suggest or promote the template.

Event template reviewing module 208 may allow users of client devices (e.g., event attendees and/or event organizers) to submit reviews for a template, for example, after the event for which the template was used. In one example, users may access (e.g., via module 204) the event object associated with the event, and the event object may include a button that allows the user to submit ratings and/or comments related to the event and/or the event template. In this scenario, module 204 may communicate with event template reviewing module 208. As another example, after an event, users may receive a message (e.g., an email message) or a pop-up window on their client devices that prompts the users to submit reviews of the event and/or event template. The message or pop-up window may include a button or link that connects the user to the event template reviewing module 208.

Reviews submitted by attendees of an event may be used (e.g., by event template reviewing module 208) in various ways. In one example, module 208 may cause reviews to be sent (e.g., via a messaging system) to the organizer of the event. In this example, the organizer may use this feedback to determine whether the event template was successful, and then the organizer may submit a subsequent review to be associated with the template. In another example, module 208 may cause the reviews from the attendees to be automatically associated with the event template used. In some examples, when a review from an attendee is associated with a template, information (e.g., profile information) about the particular users that submitted the reviews may be saved as well. The reviews may also be sent (e.g., via a messaging system) to the creator of the template. In some examples, attendees of an event may not be aware of which template was used for an event, and these attendees may submit reviews of the event in general. Still, such comments may be associated with the event template used and may be useful feedback.

Reviews submitted by organizers of events may be used (e.g., by event template reviewing module 208) in various ways. Module 208 may cause the reviews from organizers to be automatically associated with the event template used. In one example scenario, attendees of an event may submit reviews related to an event, and module 208 may cause a message to be sent to the event organizer, for example, a message that reads, “We loved the format of this meeting! We especially loved XXX.” The organizer of the event may then develop an opinion about the event template used for the meeting (e.g., things that worked well, things that could be improved, etc.). The organizer of the event may then submit a review of the template used for the event. Template reviews may be sent (e.g., via a messaging system) to the creator of the template, which allows users of a template to respond directly to the template creators and give real time feedback for the template (e.g., feedback related to effectiveness, ease of use, etc.). In this respect, creators of templates may improve their templates based on real-world interaction with their templates, which may lead to higher satisfaction of users of the templates.

As explained above, event template viewing/selection module 206 may allow a user to select a particular event template and view the details of the event template, for example, at least one review associate with the template. Because reviews of event templates may be received (e.g., via module 208) and associated with event templates (e.g., in repository 222) in real time, users that view event templates may see real time reviews for each template. Template reviews may allow a user (e.g., an event organizer) to learn about past real-world interaction of users with various templates. These reviews may allow a user to choose a template for the user's meeting that was successful for past users. These reviews may increase the productivity of an event organizer by allowing the organizer to quickly select a template for the meeting that has worked well in the past.

In some embodiments, event template viewing/selection module 206 may suggest templates to a user (e.g., templates that are most likely to be successful for the user's event). Event template viewing/selection module 206 may use various types of information to generate such suggestions, for example, information about the user (e.g., past template selections, past types of event objects created, etc.), review information associated with various templates, and the particular attendees that are associated with particular template reviews. As one specific example, a user (e.g., an event organizer) may create an event object for a particular type of event and may invite several attendees to the event. Based on this information, event template viewing/selection module 206 may suggest templates of the specified type that at least some of these particular attendees have liked in the past. In this respect, an event organizer can be confident that the template selected will be popular with at least some of the attendees of the event.

In some embodiments, event template viewing/selection module 206 may alter or tune the template browsing and/or viewing experience based on the particular attendees invited to an event. As one specific example, an organizer of an event may create an event object and select a number of attendees. Then, the organizer may browse for a template to associate with the event object. When the organizer is browsing, the particular templates that are displayed and/or suggested (and the reviews for those templates) may be biased for the particular attendees of the event. For example, templates that these particular attendees like the best may be displayed near the top of a display screen, and templates that these particular attendees disliked may be displayed at the bottom (or not at all), for example, even if those templates received generally high ratings. As another example, ratings of templates may be altered to display only ratings from these attendees or to bias the ratings average to put more weight on the ratings of these attendees. In this respect, in these embodiments, the browsing, display and suggestions of templates may be based on past experiences and feedback of the specific event attendees, which may result in the specific attendees being more satisfied with the event.

Event runtime module 210 may be accessible to a user via client device interface module 202. In some examples, event runtime module 210 may be accessible to a user via event object creating/viewing module 204. Event runtime module 210 may be accessed by a user during an event, for example, while an organizer (or other presenter) is speaking during an event. Event runtime module 210 may access an event template associated with the event. Event runtime module 210 may access a virtual moderator component of an event template, and may accept input from a user and/or provide information to a user based on the design of the virtual moderator as described below.

An event template may include a virtual moderator component. A virtual moderator component may be accessed during a meeting for which the event template is used. A virtual moderator component may track time during the event, and indicate or provide certain content (e.g., of the total content associated with the event template) at certain times during the event. As one example, a virtual moderator component may provide at least one timing cue and may indicate, for each timing cue, a portion of the content associated with the timing cue. Then, when each timing cue is provided, a virtual moderator component may cause the associated portion of the content to display.

A virtual moderator component may be specific to associated event template, and may be designed and/or configured by the creator of the template. For example, the creator of the template may specify the number of time segments, the duration of each time segment, buffer times between time segments, content associated with each time segment and the like. In one specific example, a user (e.g., a presenter) may indicate (e.g., via module 210) that the event has started. The virtual moderator component may then start to track time during the meeting, and at particular times, certain windows or sections may pop-up with content. The content may be attendee-visible content and/or organizer-visible content, as explained herein. The content may be embedded or integrated into the window or section, or the window or section may include a link to the content, as explained herein.

In some embodiments, scheduling server 200 may track and store statistics about at least one event, for example, time duration of an event, type of event (e.g., 1-on-1 meetings, company status meetings, etc.), reviews related to the event, and the like. Scheduling server 200 may provide statistics about a single event or multiple events. For example, for multiple events, scheduling server 200 may provide statistics for a particular user, such as types of events that the user attends, percentages of time spent in events of particular types, average ratings received for events of particular types, or the like. Scheduling server 200 may provide these statistics to users via a messaging system (e.g., email).

FIG. 3A is a diagram of an example display screen 300 that may be displayed via user interface 301 displayed on device display 303. Device display 303 may be similar to device display 262 of FIG. 2, for example. User interface 301 may be provided by client device interface module 202 of FIG. 2, for example. User interface 301 may be capable of displaying various screens, for example, screens 300, 320, 350, 370, 400 and 450. User interface 301 may provide information to client devices (e.g., client device 260 of FIG. 2) and may receive information from client devices to allow users to interact with the various modules in the scheduling server (e.g., modules 204, 206, 208, 210).

Display screen 300 may be displayed to a user, for example, in response to a user accessing event template viewing/selection module 206 of FIG. 2. As illustrated in FIG. 3A, display screen 300 may prompt a user to select a type of event that the user is planning such that event templates may be sorted or filtered according to the event type. Display screen 300 may display a number of event type buttons (e.g., buttons 302 to 316), where each button is associated with a different type of event and/or template type. As described above, example event and/or template types may be, without limitation, a brainstorm meeting, a company status meeting, a question and answer (Q&A) meeting, a 1-on-1 meeting, a performance review, a scrum status meeting, a feature demo, a free lecture, etc. Display screen 300 may include a scroll bar 318 that may accept user input to scroll through a number of type buttons. User interface 301 may be in a state that is ready to receive user input, for example, user input that may select a type button.

FIG. 3B is a diagram of an example display screen 320 that may be displayed via user interface 301 displayed on device display 303. Display screen 320 may be displayed to a user, for example, in response to a user accessing event template viewing/selection module 206, and then selecting an event/template type (e.g., as described above with respect to FIG. 3A). In the particular example shown in FIG. 3B, a user may have selected event/template type 3 (as can be seen by indicator/selector 336). Display screen 320 may display event template windows (e.g., windows 322 to 332) for event templates associated with a specified type (e.g., type 3). Display screen 320 may include a scroll bar 334 that may accept user input to scroll through a number of template windows. Display screen 320 may include a template type indicator/selector 336. Indicator/selector 336 may start by showing a default or selected template type (e.g., type 3). Indicator/selector 336 may accept user input to change the template type. When the template type is changed via indicator/selector 336, the template windows displayed in display screen 320 may change to show templates of the updated type. Display screen 320 may include at least one other sorting or filtering component (e.g., component 338). Component 338 may allow a user to further sort or filter the template windows by other criteria, for example, template reviews or ratings, template creator (e.g., creator profile), date modified or the like. Display screen 320 may include a back button 340 that causes user interface 301 to return to a previous screen (e.g., screen 300).

As is illustrated in FIG. 3B, each template window (e.g., windows 322 to 332) may include a number of components (e.g., title, template preview and/or review preview). A template window may include a name or title (e.g., “Template 1”). A template window may include a template preview, which may display information such as the creator of the template, a date that the template was created or modified, a preview of the content associated with template, or the like. A template window may include a review preview, which may display a summary or sample of the user reviews associated with the template. For example, a review preview may show an average rating (e.g., a number of stars) based on multiple user reviews, the number of user reviews for the template and/or a sample of at least one review. User interface 301 may be in a state that is ready to receive user input, for example, user input that may select a template (e.g., by clicking on or touching a template window).

FIG. 3C is a diagram of an example display screen 350 that may be displayed via user interface 301 displayed on device display 303. Display screen 350 may be displayed to a user, for example, in response to a user selecting a template (e.g., by selecting a template window as described above with respect to FIG. 3B). Display screen 350 may display details about the selected template. In the particular example shown in FIG. 3C, a user may have selected template 5. Display screen 350 may include a type indicator 352 that indicates the type or category of template. Display screen 350 may include a template review preview 354, which may display a summary or sample of the user reviews associated with the template. For example, a review preview may show an average rating (e.g., a number of stars) based on multiple user reviews, the number of user reviews for the template and/or a sample of at least one review.

Display screen 350 may include a content section 351 that may display content associated with the template, as described in more detail herein. Content section 351 may display attendee-visible content 356 and/or presenter-visible content 358. Content section 351 may include a scroll bar 360 that may accept user input to scroll through the content in content section 351. Display screen 350 may include a back button 362 that causes user interface 301 to return to a previous screen (e.g., screen 320). Display screen 350 may include an event creation button 364, which may allow a user to start creating an event (e.g., using module 204 of FIG. 2) using the current template. In this respect, a user may be able to associate the current template with a new event object. Alternatively, button 364 may allow a user to associate the current template with an existing event object (e.g., using a display screen similar to display screen 400 of FIG. 4A).

FIG. 3D is a diagram of an example display screen 370 that may be displayed via user interface 301 displayed on device display 303. Display screen 370 may be displayed to a user, for example, in response to a user clicking on or touching a template review preview (e.g., one of the template previews on display screen 320 or template preview 354 on display screen 350). Display screen 370 may display more details regarding the reviews (e.g., ratings and/or comments) associated with the selected template. In the specific example of FIG. 3D, a user may have clicked on or touched a template review preview associated with template 5. Display screen 370 may include a type indicator 372 that indicates the type or category of template. Display screen 370 may include a review summary 374, which may display a summary or sample of the user reviews associated with the template. For example, review summary 374 may show an average rating (e.g., a number of stars), the number of user reviews for the template and/or a sample of at least one review and/or a sample of at least one review (e.g., the best review and the worst review).

Display screen 370 may include a number of review windows (e.g., windows 376, 380). Each review window may include a summary of information about one review, for example, a rating (e.g., a number of stars) and/or a sample of a comment included in the review. Each review window may include an “expand” button (e.g., buttons 378, 382), which may accept user input and cause a full view of the associated review to be displayed. Display screen 370 may include a back button 384 that causes user interface 301 to return to a previous screen (e.g., screen 320 or 350). Display screen 370 may include an event creation button 386, which may allow a user to start creating an event (e.g., using module 204 of FIG. 2) using the current template. In this respect, a user may be able to associate the current template with a new event object. Alternatively, button 386 may allow a user to associate the current template with an existing event object (e.g., using a display screen similar to display screen 400 of FIG. 4A).

FIG. 4A is a diagram of an example display screen 400 that may be displayed via user interface 301 displayed on device display 303. Display screen 400 may be displayed to a user in a number of ways. For example, a user could navigate to a calendar function of a calendar program running on the scheduling server 200. The calendar program may provide a display screen similar to display screen 400. A user may then select a month (e.g., using selector 402) and a day (e.g., by clicking on or touching one of the day boxes in section 404). This may cause a subsequent display screen to display, for example, display screen 450, which may allow a user to select a time slot and associate a template with the event. As another example way that display screen 400 may be displayed to a user, a user may navigate to a display screen associated with a particular template (e.g., display screen 350 or 370). Then a user may click on our touch a button (e.g., button 364 or 386) to associate the particular template with an event object, which may cause display screen 400 to display. A user may select a month and day to see existing events or time slots available for events. In one specific example, a user may drag an icon associated with a selected template to an event or timeslot.

FIG. 4B is a diagram of an example display screen 450 that may be displayed via user interface 301 displayed on device display 303. Display screen 450 may be displayed to user as a result of a user selecting a particular day and time slot (e.g., via display screen 400), and selecting to create an event at that time slot. Alternatively, calendar program may offer a function to create an event before the user selects a particular time slot. Once the user selects to create an event, a user may interact with event object creation/viewing module 204, for example. Display screen 450 may allow a user to specify various details about an event, details which may be used to create an event object. Display screen may allow a user to specify a subject or title for the event, via subject component 452. Display screen may allow a user to specify a month, day and time for the event, via selectors in section 454. Display screen may allow a user to specify other details about the event such as the room, the attendees or the like, via at least one component in section 458. Display screen may include a details and/or content section 460, which may show information that is intended to be visible to attendees of the event. Display screen 450 may include a scroll bar 462 that may accept user input to scroll through details and/or content in section 460. Display screen 450 may include a back button 464 that causes user interface 301 to return to a previous screen (e.g., screen 400). Display screen 450 may include an event creation/update button 466, which may create or update an event object using the details specified in display screen 450.

Display screen 450 may include an event template selection component 456. Event template selection component 456 may allow a user to associate an event template with the event object that is being updated or is about to be created using display screen 450. As one example, a user may click on or touch event template selection component 456, and as a result, display screen 300 may display, which may start the process of guiding a user through selecting an event template (e.g., to be followed by other display screens such as 320, 350, 370). Once a template is selected for an event object, the content associated with the template may be automatically added to or integrated into the event object, for example, at section 460. In this respect, once a template is associated with an event object, if a user views an existing event object (e.g., using a screen similar to screen 450), the user may see content associated with the event object in section 460. If an attendee is viewing the event object, the attendee may see attendee-visible content in section 460. If an organizer is viewing the event object, the organizer may see organizer-visible content in section 460.

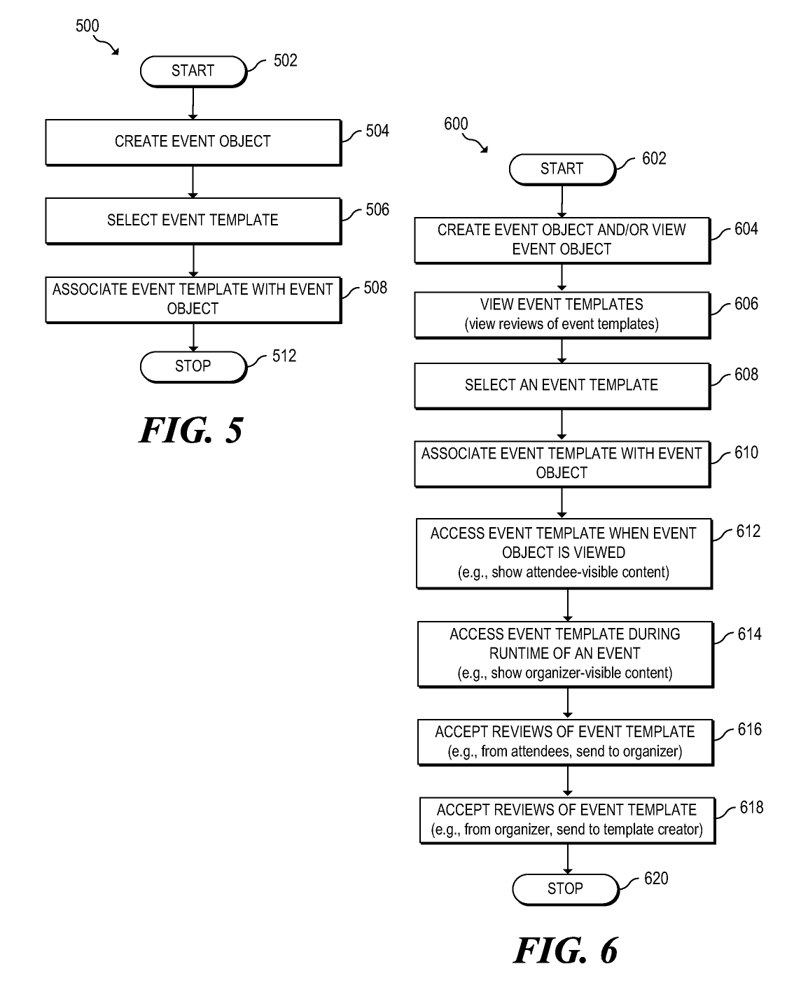

FIG. 5 is a flowchart of an example method 500 for associating event templates with event objects. Although execution of method 500 is described below with reference to scheduling server computing device 100 of FIG. 1, other suitable devices for execution of method 500 may be used, such as scheduling server computing device 200 of FIG. 2. Method 500 may be implemented in the form of executable instructions stored on a machine-readable storage medium, such as storage medium 120, and/or in the form of electronic circuitry. In alternate embodiments of the present disclosure, one or more steps of method 500 may be executed substantially concurrently or in a different order than shown in FIG. 5. In alternate embodiments of the present disclosure, method 500 may include more or less steps than are shown in FIG. 5. In some embodiments, one or more of the steps of method 500 may, at certain times, be ongoing and/or may repeat.

Method 500 may start at step 502 and continue to step 504, where scheduling server 100 may allow a user to create an event object (e.g., via instructions 122 of FIG. 1). At step 506, scheduling server 100 may allow a user to select an event template (e.g., via instructions 124). At step 508, scheduling server 100 may associate (e.g., via instructions 126) an event template with an event object, for example, a newly created event object or an existing event object. Once an event template is associated with an event object, users may view content associated with the event template when they view the event object. Method 500 may eventually continue to step 512, where method 500 may stop.

FIG. 6 is a flowchart of an example method 600 for associating event templates with event objects. Although execution of method 600 is described below with reference to scheduling server computing device 200 of FIG. 2, other suitable devices for execution of method 500 may be used, such as scheduling server computing device 100 of FIG. 1. Method 600 may be implemented in the form of executable instructions stored on a machine-readable storage medium, such as storage medium 120, and/or in the form of electronic circuitry. In alternate embodiments of the present disclosure, one or more steps of method 600 may be executed substantially concurrently or in a different order than shown in FIG. 6. In alternate embodiments of the present disclosure, method 600 may include more or less steps than are shown in FIG. 6. In some embodiments, one or more of the steps of method 600 may, at certain times, be ongoing and/or may repeat.

Method 600 may start at step 602 and continue to step 604, where scheduling server 200 may allow a user to create an event object and/or view an event object (e.g., via module 204). At step 606, scheduling server 200 may allow a user to view event templates and/or view reviews of event templates (e.g., via module 206). Scheduling server 200 may display various screens to a user (e.g., as shown in FIGS. 3A and 3D) to allow a user to browse through various event templates and view reviews associated with event templates. At step 608, scheduling server 200 may allow a user to select an event template (e.g., via module 206). A user may select an event template, for example, by interacting with button 364 or button 386 of display screens 350 or 370 respectively.

At step 610, scheduling server 200 may associate a selected event template with an event object. At step 612, scheduling server 200 may access an event template when an event object is viewed. For example, if an event attendee accesses an event object to view details of an event, attendee-visible content of the associated event template may be displayed. At step 614, scheduling server 200 may access an event template during runtime of an event (e.g., via event runtime module 210). For example, if an event organizer accesses an event object to utilize a virtual moderator component of the associated event template, organizer-visible content of the associated template may be displayed. At step 616, scheduling server 200 may accept reviews of at least one event template, for example, reviews submitted by event attendees. In this example, the reviews may be sent (e.g., via a messaging system) to the event organizer. At step 618, scheduling server 200 may accept reviews of at least one event template, for example, reviews submitted by event organizers. In this example, the reviews may be sent (e.g., via a messaging system) to the creator of the template. Method 600 may eventually continue to step 620, where method 600 may stop.

1. A server computing device for associating event templates with event objects, the server computing device comprising:
a processor to:
receive input from a first client device to create an event object that provides information about an event, wherein the event object is accessible to client devices via a network;
receive input from the first client device to select an event template from a repository of event templates, wherein the selected template includes defined content that includes non-logistical, substantive event information, wherein the non-logistical, substantive event information includes details about the structure of the event or particular content that will be provided during the event; and
associate the event object with the event template such that when client devices accesses the event object, at least part of the defined content is displayable to the client devices.

2. The server computing device of claim 1 wherein the defined content includes at least one of the following:
topics or information to be presented during the event,
at least one of a listing and organization of time segments during the event,
media to be played or shown during the event,
a link to at least one of external information and external media, and computer code that, when executed, embeds at least one of external information and external media in an event object.

3. The server computing device of claim 1, wherein the processor is further to:
receive event template review information from a second client device, wherein the second client device is associated with an attendee of the event, and wherein the event template review information includes at least one of the following:
a rating related to the event or the event template,
an answer to a question related to the event or the event template, and
a comment related to the event or the event template; and
associate the event template review information with the event template such that when the event template is viewed, at least some of the event template review information is displayable.

4. The server computing device of claim 1, wherein the processor is further to:
access the repository of event templates to allow a user of the first client device to browse through multiple event templates in the repository; and
cause display, on the first client device, of a subset of the multiple event templates in the repository based on event template review information received for at least one of the multiple event templates.

5. The server computing device of claim 4, wherein the display of the subset of the multiple event templates is further based on review information received from at least one particular attendee of the event.

6. The server computing device of claim 1, wherein the processor is further to cause display, on the first client device, of a representation of the selected event template, wherein the representation of the selected event template includes event template review information that includes at least one of the following:
a rating related to the event or the event template,
an answer to a question related to the event or the event template, and
a comment related to the event or the event template.

7. The server computing device of claim 1, wherein the processor is further to:
receive, from a second client device, an event start signal associated with the event object, wherein the event start signal indicates that the event associated with the event object is beginning or will begin within a defined period of time;
access an event runtime module associated with the event object, wherein the event runtime module accesses the event template and the defined content of the event template, and wherein the event runtime module provides at least one timing cue, and wherein the event runtime module indicates, for each timing cue, a portion of the defined content associated with the timing cue; and
cause display of the portion of the defined content associated with the timing cue on the second client device when each timing cue is provided.

8. A method for execution by a scheduling server computing device for associating event templates with event objects, the method comprising:
accessing a repository that stores multiple event templates, wherein each event template includes defined content that includes at least one of the following:
topics or information to be presented during an event,
at least one of a listing and organization of time segments during an event,
media to be played or shown during an event,
a link to at least one of external information and external media, and
computer code that when executed embeds at least one of external information and external media in an event object;
receiving input from a client device to allow a user to browse through the multiple event templates in the repository;
receiving input from the client device to allow the user to select an event template from the repository; and
associating the selected event template with an event object, the event object providing information about an event, wherein associating the event template with the event object causes at least part of the defined content of the selected event template to be displayable when users access the event object.

9. The method of claim 8, further comprising causing display, on the client device, of a representation of at least one of the multiple templates in the repository, wherein each representation includes event template review information that includes at least one of the following:
a rating related to the event or the event template,
an answer to a question related to the event or the event template, and
a comment related to the event or the event template.

10. The method of claim 8, wherein the multiple event templates in the repository are indexed to be associated with at least one of multiple categories, and wherein the method further comprises:
receiving input from the client device to allow the user to browse through the multiple categories of event templates;
receiving input from the client device to allow the user to select a category of the multiple categories; and
causing display, on the client device, of representation(s) of at least one of the multiple event templates that are indexed by the selected category.

11. The method of claim 8, further comprising causing display, on the client device, of a subset of the multiple event templates in the repository based on event template review information received for at least one of the multiple event templates, wherein the event template review information used to display the subset is received from at least one particular attendee of the event.

12. The method of claim 8, further comprising causing display, on the client device, of a subset of the multiple event templates in the repository based on template creator, wherein at least one of the multiple event templates indicates a profile for a template creator that created the template.

13. A machine-readable storage medium encoded with instructions executable by a processor of a scheduling server computing device for associating event templates with event objects, the machine-readable storage medium comprising:
instructions for allowing a first client device to access an event template repository that includes multiple event templates, wherein each template in the repository includes defined content;
instructions for receiving reviews from multiple other client devices, wherein each of the reviews includes a rating or a comment about one of the event templates in the repository;
instructions for causing display, on the first client device, of a subset of all the event templates in the repository, wherein the subset is based on the reviews associated with the event templates in the subset;
instructions for receiving input from the first client device to select one of the templates in the subset; and
instructions for associating the selected event template with an event object, the event object providing information about an event, wherein associating the event template with the event object causes at least part of the defined content of the selected event template to be displayable when users access the event object.

14. The machine-readable storage medium of claim 13, wherein the displaying of the subset is further based on event template selections that a user of the first client device has made in the past.

15. The machine-readable storage medium of claim 13, wherein the displaying of the subset is further based on whether the reviews associated with the event templates in the subset are reviews from particular attendees of the event, wherein the particular attendees are indicated by the event object.

16. The machine-readable storage medium of claim 13, further comprising:
instructions for receiving input from the first client device to access, during the event, a runtime module associated with the selected event template; and
instructions related to the event runtime module for:
tracking time during the event;
indicating at least one time point during the event; and
for each time point, causing a portion of the defined content to display.
